(19) United States
(12) Patent Application Publication
(10) Pub. No.: US 2009/0035727 A1
(43) Pub. Date: Feb. 5, 2009

(54) DENTAL DEVICE

(76) Inventor: Fari MAISSAMI, Hinsdale, IL (US)

Correspondence Address: Kevin D. Erickson;Pauley Peterson & Erickson, Suite 365, 2800 West Higgins Road, Hoffman Estates, IL, 60169, US

(21) Appl. No.: 12/181,148

(22) Filed: Jul. 28, 2008

Related U.S. Application Data
(60) Provisional application No. 60/962,228, filed on Jul. 27, 2007.

(51) Int. Cl. A61C 5/02

(52) U.S. Cl. 433/224; 433/216

(57) ABSTRACT

A dental device including an elongated handle and an access handle formed along the elongated handle. A tip portion is formed at a distal end of the access handle and tapers to a point flocked with a plurality of bristles. A weakened portion is formed between the access handle and the elongated handle thereby permitting separation of the access handle and the tip portion relative to the elongated handle.

This application claims the benefit of U.S. Provisional Application No. 60/962,228 filed 27 Jul. 2007.

### BACKGROUND OF THE INVENTION

This invention relates generally to device for cleaning teeth and, more particularly, to a anatomically sensitive endodontic applicator.

Conventional fiber coated applicators are generally used throughout dentistry to apply dental composition to a tooth surface or region. Recently, these applicators for applying composition to a tooth surface have been introduced to be used in endodontics procedures as well. Several problems or shortcomings result from the applicators for applying dental composition to a tooth surface or region when used for endodontics procedures. Given the structural form and shape of these applicators are not anatomically correct for a root canal and generally do not comply with the professional standard form and shape of endodontics files and reamers, the utility of these conventional fiber coated applicators for complete endodontic procedure is inadequate.

Other conventional applicators are primarily used for applying dental composition to a tooth surface with some variation of shapes or form, while extending the fiber coating to a more elongated surface of the neck of the applicator. Such applicators do not comply with the correct anatomical form of a root canal. As a result, the utility of these applicators is limited to application of bonding agent to an onlay preparation or applying a uniform coat of a bonding agent to an inlay preparation or in a post-space preparation. Such applicators may also be utilized to apply bonding agent evenly along the entire area of an onlay preparation or treating the entire cavity wall of a class II restoration in a single application. Other uses include applying bonding agent to a traditional class I preparation. Such applicators, while useful for the described procedures, are generally anatomically incorrect in form and shape to have straight line access to a root canal. Their form or shape limits the practitioner to have straight utilitarian access to a root canal.

In view of the above, there is a need and a demand for an anatomically correct applicator that corresponds to the profession's structure of endodontic files or reamers for a utilitarian use in an endodontic procedure. In particular, there is a need and a demand for an applicator that is anatomically and structurally precise and correct that provides a complete utilitarian access to a root canal in endodontic procedures.

### SUMMARY OF THE INVENTION

The dental device according to this invention relates to a device and method for applying a dental composition into a root canal and/or cleaning a root canal in an endodontics procedure. More particularly, this invention relates to an anatomically correct or sensitive endodontic device that penetrates a root canal with a coated or flocked tip at a distal portion of the tip with a plurality of fibers for applying dental material and/or cleaning a dental root canal in an endodontics procedure.

The invention preferably follows the correct anatomical shape of a root canal, or the industry's standard shape of endodontics files and reamers in order to facilitate access to a root canal. Unlike the industry standard files, generally constructed of rigid materials such as metal or steel, the dental device according to this invention is preferably constructed of a unitary molded plastic body that includes plastic, pliable characteristics facilitating various features of the subject invention. A preferred anatomical shape of the device preferably establishes a correct glide path for straight line access to a root canal in an endodontics procedure.

The general object of the invention is accomplished through an anatomically correct applicator having a structural body that corresponds to the profession's endodontic files or reamers with a distal end portion of the applicator flocked with a plurality of fibers in an elongated form.

Other objects and advantages of this invention are apparent to those skilled in the art, in view of the following detailed description taken in conjunction with the appended claims and drawings.

### BRIEF DESCRIPTION OF THE DRAWINGS

FIG. 1 is a side perspective view of a dental tool, according to one preferred embodiment of this invention;

FIG. 2 is a side view of the dental tool, as shown in FIG. 1;

FIG. 3 is a side view of the dental tool, as shown in FIG. 1, opposite the side view shown in FIG. 2;

FIG. 4 is a front view of the dental tool, as shown in FIG. 1;

FIG. 5 is a back view of the dental tool, as shown in FIG. 1;

FIG. 6 is a side perspective view of the dental tool according to one preferred embodiment of this invention having a flocked end portion;

FIG. 7 is a side view of the dental tool according to one preferred embodiment of the invention;

FIG. 8 is a side view of a separation action of the dental tool shown in FIG. 7;

FIG. 9 is a side view of the dental tool after separation; and

FIG. 10 is a schematic side view of a use of a dental tool according one preferred embodiment of this invention.

### DETAILED DESCRIPTION OF THE INVENTION

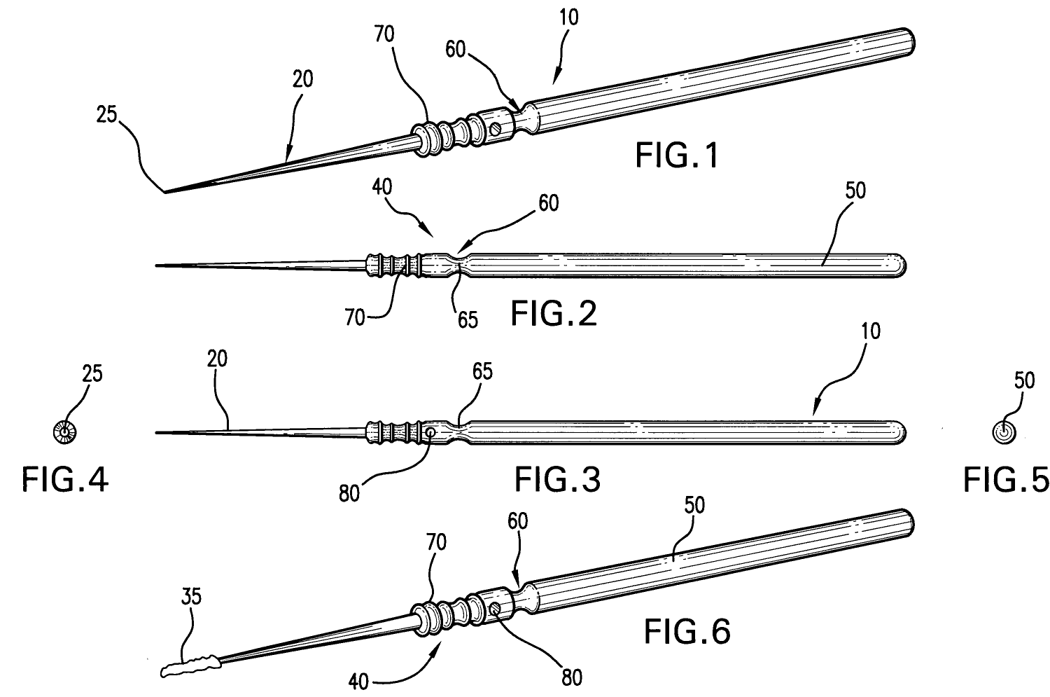

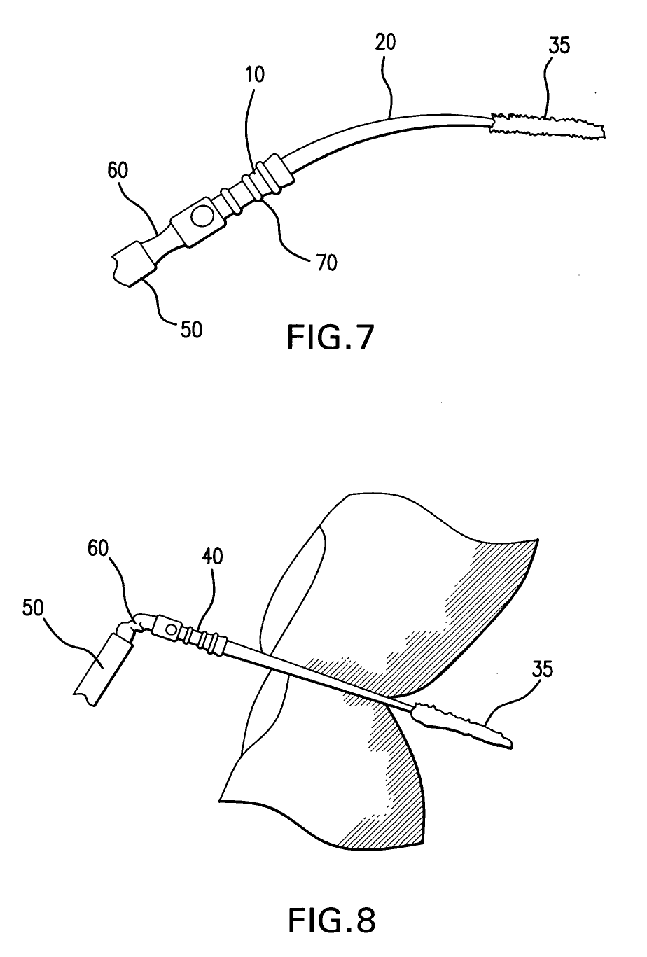

Referring to FIGS. 1-10, the present invention provides a dental device 10 that includes elongated handle 50 ultimately transitioning to tip portion 20. Dental device 10 is preferably formed in a unitary molded body, for instance, with an injection molded plastic construction. Dental device 10 may be formed of any other suitable material that is generally flexible, sterile, non-toxic and/or preferably inexpensive so as to promote disposability.

Access handle 40 is preferably formed along elongated handle 50. Access handle 40 may include one or more circumferential ribs positioned along access handle 40, thereby partially defining access handle 40. Such circumferential ribs 70 preferably enable a firm grip of dental device 10 particularly during use. Circumferential ribs 70 preferably protrude from access handle 40 to provide a fingerhold for a practitioner to grasp when using dental device 10 in the tight areas generally available in dental work.

Tip portion 20 is preferably formed at a distal end of access handle 40 and preferably tapers to a point 35. Tip portion 20 is further preferably flocked with a plurality of bristles 35. In one preferred embodiment of this invention, a plurality of bristles 35 are disposed on tip portion 20, as shown in FIGS. 6-10. Preferably, dental device 10, shown in FIGS. 1-5, further includes bristles 35 disposed on tip portion 20. However, for clarity purposes, dental device 10 as shown in FIGS. 1-5 does not include bristles 35 disposed on or coating at least a portion of tip portion 20. Bristles 35 can be disposed on tip portion 20 using any suitable method or procedure, such as a flocking procedure that coats at least a portion of tip portion 20, particularly pint 25 defined at the distal end of tip portion 20.

Tip portion 20 is preferably tapered so as to enable insertion into a tooth root during a root canal process such as shown in FIG. 10. The taper preferably begins at access handle 40 and tapers gradually to the point 25. In such a manner, access handle 40 and/or elongated handle 50 may be manipulated so as to insert tip portion 20 into root.

According to one preferred embodiment of this invention, dental device 10 includes tip portion 20 that is freely pliable into a desired configuration. Specifically, tip portion 20 is preferably bendable with respect to elongated handle 50. In one preferred embodiment of this invention, tip portion 20 is bendable and, specifically, pliable with respect to elongated handle 50. Preferably, dental device 10 is pliable to permit tip portion 20 to be bent in a desired position or configuration that permits access to a root canal, such as shown in FIG. 10.

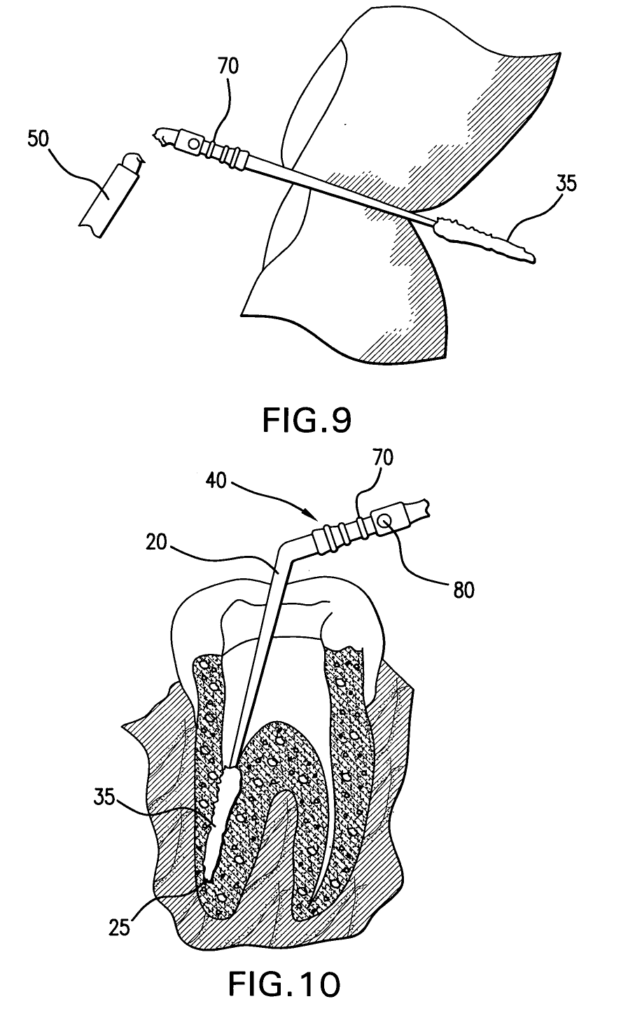

Referring to FIGS. 1-9, in one preferred embodiment of this invention, at least one weakened portion can be formed in dental device 10, preferably between elongated handle 50 and access handle 40. According to a preferred embodiment of this invention, weakened portion 60 formed between access handle 40 and elongated handle 50 permits a user to snap off access handle 40 from elongated handle 50 as shown in FIGS. 8 and 9. Weakened portion 60 preferably comprises a reduced diameter shoulder 65 formed between elongated handle 50 and access handle 40. Weakened portion 60 may alternatively comprise some other structure or treatment to dental device 10 that permits a clean break between elongated handle 50 and access handle 40 and more specifically wherein tip portion 20 is separable from elongated handle 50 at the weakened portion.

Such a separation permits a practitioner to choose a longer tool having an easier grip or a shorter tool having more maneuverability. According to a preferred embodiment of the invention, access handle 40 may further comprise at least one through hole 80 positioned within access handle 40. Through hole 80 may receive a length of string or floss that may be looped around a finger or wrist of a user so that when dental device 10 is reduced in size to access handle 40 and tip portion 20, the resulting compact tool is not lost in the mouth or throat of the patient during use.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A dental device comprising:
an elongated handle;
an access handle formed along the elongated handle;
a tip portion formed at a distal end of the access handle, the tip portion tapering to a point flocked with a plurality of bristles; and
a weakened portion formed between the access handle and the elongated handle.

2. The dental device of claim 1 wherein the access handle comprises a plurality of circumferential ribs.

3. The dental device of claim 1 wherein the weakened portion comprises a reduced diameter shoulder formed between the elongated handle and the access handle.

4. The dental device of claim 1 comprising a unitary molded body.

5. The dental device of claim 1 wherein the tip portion is freely pliable into a desired configuration.

6. The dental device of claim 1 wherein the tip portion is bendable with respect to the elongated handle.

7. The dental device of claim 1 wherein the tip portion is separable from the elongated handle at the weakened portion.

8. The dental device of claim 1 wherein the access handle further comprises at least one through hole positioned within the access handle.

9. A dental device comprising:
an elongated handle;
an access handle formed along the elongated handle;
a plurality of circumferential ribs formed at a proximate end of the access handle;
a tip portion formed at a distal end of the access handle, the tip portion tapering to a point flocked with a plurality of bristles; and
a reduced diameter shoulder formed between the elongated handle and the access handle, the access handle separable from the elongated handle along the reduced diameter shoulder.

10. The dental device of claim 9 comprising a unitary molded body.

11. The dental device of claim 9 wherein the tip portion is freely pliable into a desired configuration.

12. The dental device of claim 11 wherein the tip portion is bendable with respect to the elongated handle.

13. The dental device of claim 9 wherein the access handle further comprises at least one through hole positioned within the access handle.

14. A dental device comprising:
an elongated handle;
an access handle formed along the elongated handle, the access handle including a through hole formed therein;
a plurality of circumferential ribs formed at a proximate end of the access handle;
a tip portion formed at a distal end of the access handle, the tip portion tapering to a point flocked with a plurality of bristles; and
a weakened portion defined by a reduced diameter shoulder formed between the elongated handle and the access handle.

15. The dental device of claim 14 wherein the tip portion is separable from the elongated handle at the weakened portion.
